(19) United States
(12) Patent Application Publication
(10) Pub. No.: US 2011/0088620 A1
(43) Pub. Date: Apr. 21, 2011

(54) DRUM COATER HAVING A NIR MEASURING UNIT

(75) Inventor: Frank Maurer, Inzlingen (DE)

(73) Assignee: GLATT MASCHINEN-UND APPARATEBAU AG, Pratteln (CH)

(21) Appl. No.: 12/996,184

(22) PCT Filed: Jun. 10, 2009
(86) PCT No.: PCT/EP2009/057139

§ 371 Date: Dec. 3, 2010

(30) Foreign Application Priority Data
Jun. 10, 2008 (CH) 00876/08

(51) Int. Cl. B05C 11/00

(52) U.S. Cl. 118/712

(57) ABSTRACT

The film coating device having a perforated drum is provided with a stationary NIR measuring unit on the outside of the rotating drum wall. The measurement is made through the drum wall.

The invention relates to a film coating device with a rotating drum that has a perforated cylindrical wall, and a unit for NIR spectral measurement of the coating. For the purpose of this description, the term film coating device also comprises devices for applying functional coatings onto tablets, etc. Such devices are also known in the field under the term drum coater.

Within the scope of quality control for pharmaceutical products it is advantageous when the coating is monitored during the coating process in drum coaters by means of NIR spectroscopy. The spray cans and if appropriate, measurement units are usually attached to stationary brackets or poles, which project into the interior of the drum through its opening on the front and/or can be retracted or moved out. Moreover, this opening, which remains open during the coating process, is also used for loading and unloading the drum.

In the many functions, which must be served by the opening, the available space reaches a limit, which would prevent additional functions, for example, additionally desired measurements. Further, there is a problem of the failure of a measurement due to the spray unit.

The invention is based on the objective of eliminating this bottleneck.

Surprisingly, it was found that NIR spectral measurements are possible through the perforated drum wall of a drum coater, and lead to qualitative measurement results of high quality.

According to the invention, the problem is solved thereby, that the NIR measurement unit is mounted stationary at the exterior side of the rotating drum wall and the measurement is performed through the drum wall.

In the following, a preferred example of an embodiment is described in conjunction with the enclosed drawing. The FIGURE illustrates a schematic, perspective illustration of a drum coater for coating tablets.

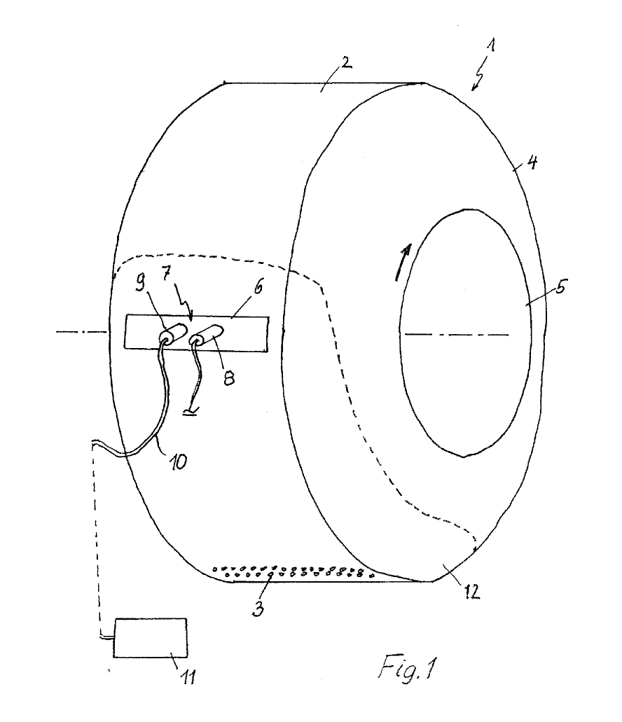

The typical drum 1 of a drum coater shown in FIG. 1 consists essentially of a cylindrical wall 2 and conical lateral walls 4 that are attached to the cylindrical wall 2, whereby the lateral wall on the front is provided with an opening 5. The cylindrical wall has a perforation 3 that is indicated schematically in the drawing. The opening 5 is for loading and unloading the drum and is further used for mounting stationary units such as, for example, a spray unit, as well as perhaps other devices for treatment and measurement of a tablet bed 12 in the interior of the drum.

At the exterior side of the drum, approximately at the level of the drum axle, an NIR measurement unit 7 is attached to a stationary bracketing 6. The bracketing 6 is schematically indicated in the drawing. In the specific embodiment it is a part of a housing (not shown), in which the drum is mounted.

The NIR measurement unit 7 consists of a light source 8, and a measuring head 9. In the present embodiment, a tungsten halogen lamp with 7.5 W is used as light source 8, and as measuring head, a commercially available device called Iris 7. The light emission of the lamp is arranged in the present embodiment at a distance of approximately 10 mm from the drum surface in such a way that the emitted light impinges perpendicular onto the drum and sometimes reaches through the perforation into the interior of the drum and to the tablet bed. In place of the devices used in the present embodiment, other commercially available light sources and measuring heads can, of course, be used as well.

During the coating process, i.e. when a tablet bed is located in the drum and is being rotated there, a part of the light is reflected spectrally resolved, and in turn sometimes reaches through the perforations to the outside, where it impinges on the measuring head 9. The input window of the measuring head is here likewise located at a distance of approximately 10 mm from the drum surface.

The optical signal captured by the measuring head 9 is conveyed by a light wave guide 10 to a spectrometer 11. As spectrometer, a commercially available device by the name of Tidas II is used in the present embodiment. It is suitable for capturing a spectrum of 1100 to 2100 nm. Of course, other comparable devices can also be used. Thereby, the spectrum that can be captured can comprise other bands.

In experiments it was first determined that the portion of the light that is reflected at the tablet bed that reaches to the measuring head and is captured there is still sufficient for generating a useable signal, from which the spectrum of the tablet bed can be reliably determined. In further experiments it was found that influences of the drum wall do not interfere with the spectrum of the tablet bed or can easily be compensated.

As an example, comparative measurements were performed on acetyl salicylic acid tablets and specifically, first measurements through the perforated drum wall, and second measurements without impediment between the tablet bed and the measuring head. The spectra that were obtained in the two different measurement situations are essentially congruent with the exception of a linear displacement, which can be eliminated by means of a base-line correction.

1. Film coating device using a drum with a perforated cylindrical wall and a unit for NIR spectral measurement, characterized by, that the NIR measurement unit is mounted stationary at the exterior side of the rotating drum wall, and the measurement is performed through the drum wall.

2. Film coating device according to claim 1, characterized by, that the NIR measurement unit comprises a light source and a measuring head, that are located at a distance from the drum wall depending on the respective measuring device.
